(19) United States
(12) Patent Application Publication
(10) Pub. No.: US 2012/0276267 A1
(43) Pub. Date: Nov. 1, 2012

(54) OIL COMPOUND TO REDUCE THE FORMATION OF FROST IN FROZEN PRE-FRIED FOOD PRODUCTS

(76) Inventor: Fredy Leonardo Daza Leguizamon, Bogota (CO)

(21) Appl. No.: 13/520,162

(22) PCT Filed: Dec. 29, 2009
(86) PCT No.: PCT/IB2009/007902

§ 371 Date: Jun. 29, 2012

(51) Int. Cl. A23D 9/007; A23L 3/36; A23L 1/217; A23L 1/01

(52) U.S. Cl. 426/546; 426/541; 426/438

(57) ABSTRACT

An oil compound used in the preparation of frozen pre-fried food products that reduced the formation of ice crystals or frost.

### CROSS-REFERENCE TO RELATED APPLICATIONS

This application is a U.S. National Phase application of International Patent Application No. PCT/IB2009/007902, titled “Fatty Composition that Reduces the Formation of Frost on Frozen, Pre-Fried Food Products.” International Patent Application No. PCT/IB2009/007902 was filed on Dec. 29, 2009, and was not published in English. The disclosure of International Patent Application No. PCT/IB2009/307902 is hereby incorporated by reference in its entirety for all purposes.

### COPYRIGHT NOTIFICATION

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

The present invention relates to an oil compound, and in particular, to an oil compound to reduce the formation of frost or ice crystals in frozen pre-fried food products. 2. Description of the Related Art

Presently, various types of food products, such as French fries, cassava, and plantains, are available as frozen pre-fried food products. Preparation of these frozen pre-fried food products may involve the following preparation stages: washing, peeling, cutting, blanching, drying, pre-frying, cooling, individual quick freezing (IQF), packaging, and storing.

However, if frozen pre-fried food products are subject to temperature changes during transportation or storage, frost or ice crystals may form as free water in the frozen pre-fried food products turns to a liquid state as the temperature increases above the freezing point and freezes again when the temperature decreases below the freezing point again.

For the consumer, the excess presence of ice crystals on frozen pre-fried food products is interpreted as indicating that a product has been in storage for a long time and may not be as fresh. In addition, the frost results in clumping of the frozen pre-fried food products within the packaging, preventing the consumer from easily apportioning the frozen pre-fried food products at the time of utilization. Moreover, when preparing the frozen pre-fried food products for consumption, for example by deep frying or skillet frying, the excess frost causes a strong thermal shock with the hot oil, producing oil spattering.

Accordingly, there is a need for an oil compound to prevent the formation of frost on frozen pre-fried food products.

### SUMMARY OF THE INVENTION

The present invention relates to an oil compound used during preparation of frozen pre-fried products to reduce the formation of frost.

Additional goals and advantages of the present invention will become more evident in the description of the figures, the detailed description of the invention, and the claims.

The foregoing and/or other aspects and utilities of the present invention may be achieved by providing an oil compound including between 90% and 99.99% by weight vegetable oil, based on a total weight of the oil compound, between 0.15% and 0.45% by weight emulsifier, based on a total weight of the oil compound, between 0.01% and 0.02% antioxidant, based on a total weight of the oil compound.

In another embodiment, the vegetable oil is at least one of palm oil, fractions of palm oil, sunflower oil, high oleic sunflower oil, soy oil, olive oil, corn oil, canola oil, sesame oil, safflower oil, and mixtures thereof.

In another embodiment, the emulsifiers are at least one of distilled mono- and diglycerides, lecithin, esters of citric acid, tartaric acid, lactic acid, esters of sorbitan, and mixtures thereof.

In another embodiment, the antioxidants are at least one of tert-butylhydroquinone, butylhydroxytoluene, and mixtures thereof.

In another embodiment, the vegetable oil is one of between 93% and 99.85% by weight and between 96% and 99.75% by weight of the total weight of the oil compound.

In another embodiment, the emulsifiers is one of between 0.20% and 0.40% by weight and between 0.25% and 0.35% by weight of the total weight of the oil compound.

In another embodiment, the vegetable oil is palm oil, its fractions, or a combination thereof.

In another embodiment, when used to pre-fry a food product for 60 seconds during the preparation of a frozen pre-fried food product, an amount of frost formed in the frozen pre-fried food product is less than an amount of frost formed in a same frozen pre-fried food product prepared by pre-frying the food product for 60 seconds in palm oil shortening, when subjected to a 1 hour period of room temperature storage between periods of storage at a below freezing temperature.

In another embodiment, an amount of spattering produced when the frozen pre-fried food product pre-fried with the oil compound is cooked in 150 grams of palm olein at 180 degrees Celsius as measured during the first 30 seconds of cooking is between 20% and 69% of the spattering produced by the pre-fried food product pre-fried with the palm oil shortening, when the food product is cooked in 150 grams of palm olein at 180 degrees Celsius as measured during the first 30 seconds of cooking.

The foregoing and/or other aspects and utilities of the present invention may be also achieved by providing a method to reduce the formation of frost in frozen pre-fried food products, including pre-frying a food product in a oil compound, and freezing the food product, wherein the oil compound includes between 90% and 99.99% by weight a mixture of vegetable oils, based on a total weight of the oil compound, between 0.15% and 0.45% by weight emulsifier, based on a total weight of the oil compound, and between 0.01% and 0.02% antioxidants, based on a total weight of the oil compound.

In another embodiment, the food product is potato French fries.

In another embodiment, when the food product is pre-fried with the oil compound for 60 seconds, an amount of frost formed in the frozen pre-fried food product is less than an amount of frost formed in a same frozen pre-fried food product prepared by pre-frying the food product for 60 seconds in palm oil shortening, when subjected to a 1 hour period of room temperature storage between periods of storage at a below freezing temperature.

In another embodiment, an amount of spattering produced when the frozen pre-fried food product pre-fried with the oil compound is cooked in 150 grams of palm olein at 180 degrees Celsius as measured during the first 30 seconds of cooking is between 20% and 69% of the spattering produced by the pre-fried food product pre-fried with the palm oil shortening, when the food product is cooked in 150 grams of palm olein at 180 degrees Celsius as measured during the first 30 seconds of cooking.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1. illustrates a reduction of frost formation on frozen products pre-fried with oil compounds according to embodiments of the present invention.

FIG. 2. illustrates a reduction in clumping on frozen products pre-fried with oil compounds according to embodiments of the present invention.

FIG. 3. illustrates a reduction in spattering when pre-frying food products with oil compounds according to embodiments of the present invention.

FIG. 4. illustrates taste and smell profiles of frozen products pre-fried with oil compounds according to embodiments of the present invention.

The drawings above are not necessarily to scale, with emphasis instead generally being placed upon illustrating the principles of the present invention. Further, some features may be exaggerated to show details of particular components. These drawings/figures are intended to be explanatory and not restrictive regarding this invention

### DETAILED DESCRIPTION OF THE EMBODIMENTS

Reference will now be made in detail to the various embodiments of the present invention. The embodiments are described below to provide a more complete understanding of the components, processes and apparatuses of the present invention. Any examples given are intended to be illustrative, and not restrictive. Throughout the specification and claims, the following terms take the meanings explicitly associated herein, unless the context clearly dictates otherwise. The phrases “in some embodiments” and “in an embodiment” as used herein do not necessarily refer to the same embodiment(s), though they may. Furthermore, the phrases “in another embodiment” and “in some other embodiments” as used herein do not necessarily refer to a different embodiment, although they may. As described below, various embodiments of the present invention may be readily combined, without departing from the scope or spirit of the present invention.

As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In one embodiment, an oil compound according to embodiments of the present invention reduces the formation of ice crystals on food products which undergo temperature changes after freezing when the food products were pre-fried with the oil compound.

In an embodiment of the present invention, the oil compound includes a mixture of vegetable oils, emulsifiers, and antioxidants.

In an embodiment of the present invention, the vegetable oils may include palm oil, fractions of palm oil, sunflower oil, high oleic sunflower oil, soy oil, olive oil, corn oil, canola oil, sesame oil, safflower oil, or mixtures thereof.

In an embodiment of the present invention, the emulsifiers may include distilled mono- and diglycerides, lecithin, esters of citric acid, tartaric acid, lactic acid, esters of sorbitan, polyoxyethylene sorbitan monooleates, monostearates of polyoxyethylene sorbitan, or mixtures thereof.

In an embodiment of the present invention, the oil compound may include a vegetable oil or a mixture of vegetable oils, in an amount equal to between 90% and 99.99%, by weight, of the total weight of the oil compound. In another embodiment, the oil compound may include between 93% and 99.85% or between 96% and 99.75%, by weight of the vegetable oil or vegetable oil mixture.

In one embodiment of the present invention, the vegetable oil is palm oil or its fractions, or a mixture thereof.

In an embodiment of the present invention, the oil compound may include an emulsifier in an amount equal to between 0.15% and 0.45%, by weight, of the total weight of the oil compound. In another embodiment, the oil compound may include between 0.20% and 0.40%, or between 0.25% and 0.35% by weight of an emulsifier.

In an embodiment of the present invention, the oil compound may include an antioxidant in an amount equal to between 0.01% and 0.02% by weight of the total weight of the oil compound.

In an embodiment of the present invention, the oil compound is used to pre-fry food products during the preparation of frozen pre-fried food products. In one embodiment, the frozen pre-fried food products are potato French fries.

### Example 1

In one embodiment of the present invention, an oil composition was used to pre-fry 500 grams of potatoes of the R12 variety and compared to potatoes pre-fried in a conventional shortening. These potatoes were previously selected, washed, peeled, cut, blanched, and dried. The potatoes were pre-fried in a PALLOMARO deep-fryer (ref.: Electric Fryer, model EF171 with a 7 kg capacity and dimensions of 325×290×360 mm). 500 grams of potatoes where pre-fried in identical equipment using 7 kg of conventional shortening (derived from palm oil and its fractions) and using 7 kg of the oil compound according to an embodiment of the present invention.

For both cases, the pre-frying time was 60 seconds. After pre-frying, the potatoes were allowed to cool at room temperature for approximately 10 minutes. After drying, the potatoes were frozen in a HYBER brand flash-freezing equipment (model APM606S, voltage of 230 V, frequency of 60 Hz, power of 1100 W) at a temperature of −29° C. for 300 seconds. The potatoes were then stored in the flash freezer for 72 hours at temperatures between −19 and −29°. Then, the potatoes were removed from the flash freezer and kept at room temperature for one hour. After the end of the one hour, the potatoes were stored in the freezer of a 9 cubic feet Challenger Fresh Master home use refrigerator for a week. After the week, the potatoes were removed, and the generation of ice crystals and the clumping of the potatoes was compared.

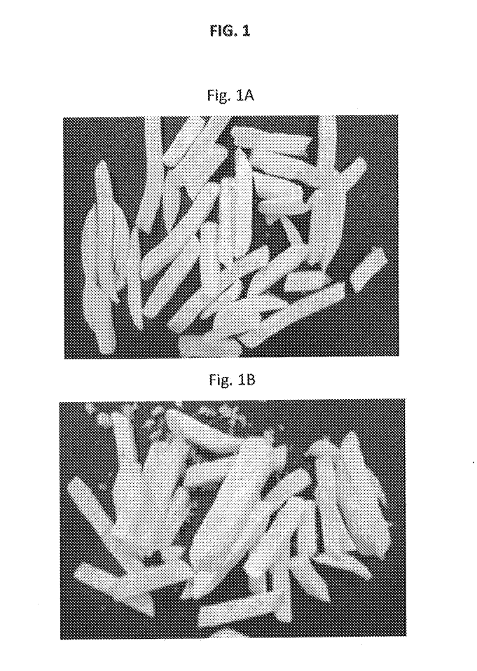

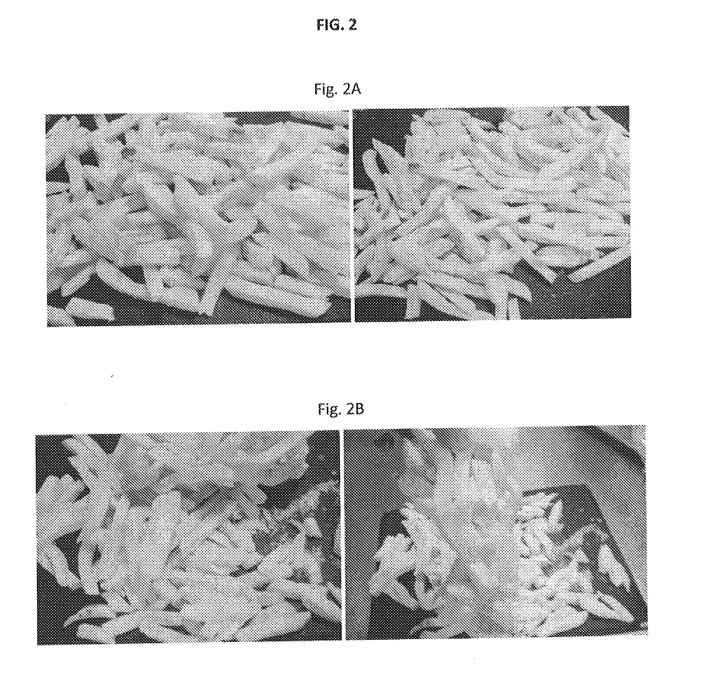

As illustrated in FIGS. 1 and 2, a reduced generation of ice crystals was observed, as well as a lower degree of clumping, in the potatoes pre-fried in the oil compound as compared to potatoes pre-fried in the conventional shortening.

FIG. 1 illustrates a reduction of ice crystal formation by the use of an oil compound according to an embodiment of the present invention. FIG. 1A illustrates frozen potatoes that have been pre-fried with the oil compound and which exhibit a much lower amount of ice crystals than those in FIG. 1B, which illustrate frozen potatoes pre-fried in the conventional shortening, FIGS. 1A and 1B also illustrate how potatoes pre-fried in the oil compound clump less than those pre-fried in the conventional shortening.

FIG. 2 more clearly illustrates the reduction of clumping. FIG. 2A illustrates clumping in frozen potatoes pre-fried in the oil compound. FIG. 2B illustrates frozen potatoes pre-fried in the conventional shortening. As illustrated in FIGS. 2A and 2B, increased clumping of the potatoes is evident in the frozen potatoes pre-fried in the conventional shortening.

Additionally, spatter measuring tests were conducted by cooking the potatoes. The cooking of the potatoes pre-fried in the conventional shortening and pre-fried in the oil compound according to an embodiment of the present invention was done by preheating 150 g of palm olein to 180° C. in a 24 cm diameter skillet and frying 100 g of each of the potatoes in this oil. The spatter measurement was conducted by placing an absorbent and/or Kraft paper, which was previously dehydrated for 12 hours with 1000 g of adsorbent material in a hermetically sealed desiccator. This paper was affixed to a 30 cm diameter frame, and after frying, the amount of oil collected on the paper from spattering during the first 30 seconds of frying was assessed.

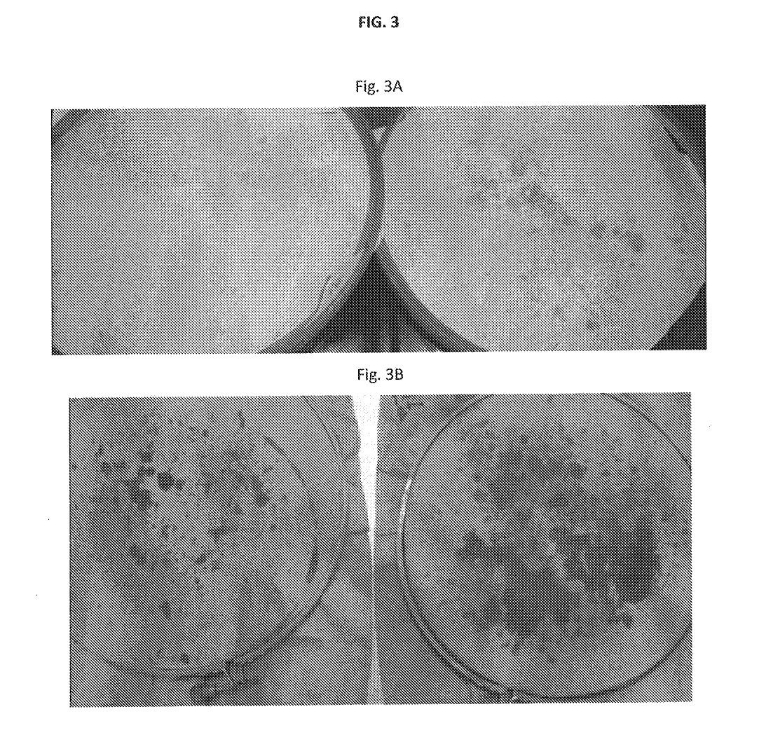

As illustrated in FIG. 3, a lower range of spattering, between 20% and 69% by weight was observed in the potatoes pre-fried in the oil compound (FIG. 3A) as compared to the spattering produced by the frozen potatoes pre-fried in the conventional shortening.

As illustrated in FIGS. 3A and 3B, the area of oil spattering is much smaller when cooking frozen potatoes pre-fried in the oil compound (FIG. 3A) than the area seen in FIG. 3B corresponding to cooking frozen potatoes pre-fried in the conventional shortening.

Finally, the cooked potatoes were evaluated by sensory means by a panel that judged the color, smell, taste and texture of the processed potatoes.

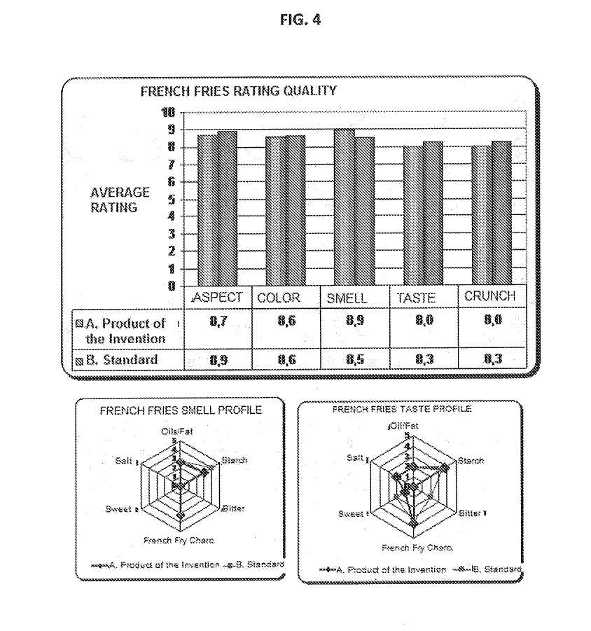

FIG. 4 illustrates a graph of the color, smell, taste, and texture profiles of the cooked potatoes pre-fried with the oil compound as compared to potatoes pre-fried in the conventional shortening. As illustrated in FIG. 4, no significant difference is observed in the color, smell, taste, and texture profiles of the potatoes as ascertained by a panel.

In addition, the physicochemical properties of the conventional shortening and the oil compound were evaluated after 8 hours of pre-frying, measuring the parameters of free acidity expressed as % of fatty oleic acid (reference method AOCS Ca 5a-40), peroxide index expressed in mEq O2/kg (reference method AOCS Cd 8-53), smoke point expressed in ° C. (reference method AOCS Cc 9a-48), and polar compounds expressed in % of polar compounds by using a portable, EBRO brand, model FOM310, polar compound meter. The results of these evaluations are illustrated in Table 1 below.

TABLE 1
Physicochemical results for the oils after 8 hours of pre-frying.

| | Standard | |
|---|---|---|
| Analysis | shortening | Oil Compound |
| Free acidity (% oleic acid) | 0.04 | 0.04 |
| Peroxide index (mEq O₂/kg) | 6.08 | 3.41 |
| Polar compounds (%) | 5.0 | 4.0 |
| Smoke point (° C.) | 245 | 240 |

As illustrated in Table 1, the values obtained from the oil compound after 8 hours of pre-frying do not exhibit a significant difference when compared to the values obtained from the conventional shortening. In addition, the oil compound exhibited good quality parameters.

Although a few embodiments of the present invention have been shown and described, it will be appreciated by those skilled in the art that changes may be made in these embodiments without departing from the principles and spirit of the present invention, the scope of which is defined in the appended claims and their equivalents.

1. An oil compound comprising:
between 90% and 99.99% by weight vegetable oil, based on a total weight of the oil compound;
between 0.15% and 0.45% by weight emulsifier, based on a total weight of the oil compound; and
between 0.01% and 0.02% antioxidant, based on a total weight of the oil compound.

2. The oil compound of claim 1, wherein the vegetable oil is at least one of palm oil, fractions of palm oil, sunflower oil, high oleic sunflower oil, soy oil, olive oil, corn oil, canola oil, sesame oil, safflower oil, and mixtures thereof.

3. The oil compound of claim 1, wherein the emulsifiers are at least one of distilled mono- and diglycerides, lecithin, esters of citric acid, tartaric acid, lactic acid, esters of sorbitan, and mixtures thereof.

4. The oil compound of claim 1, wherein the antioxidants are at least one of tert-butylhydroquinone, butylhydroxytoluene, and mixtures thereof.

5. The oil compound of claim 1, wherein the vegetable oil is one of between 93% and 99.85% by weight and between 96% and 99.75% by weight of the total weight of the oil compound.

6. The oil compound of claim 1, wherein the emulsifiers is one of between 0.20% and 0.40% by weight and between 0.25% and 0.35% by weight of the total weight of the oil compound.

7. (canceled)

8. The oil compound of claim 2, wherein the vegetable oil is palm oil, its fractions, or a combination thereof.

9. The oil compound of claim 2, wherein, when used to pre-fry a food product for 60 seconds during the preparation of a frozen pre-fried food product, an amount of frost formed in the frozen pre-fried food product is less than an amount of frost formed in a same frozen pre-fried food product prepared by pre-frying the food product for 60 seconds in palm oil shortening, when subjected to a 1 hour period of room temperature storage between periods of storage at a below freezing temperature.

10. The oil compound of claim 8, wherein, an amount of spattering produced when the frozen pre-fried food product pre-fried with the oil compound is cooked in 150 grams of palm olein at 180 degrees Celsius as measured during the first 30 seconds of cooking is between 20% and 69% of the spattering produced by the pre-fried food product pre-fried with the palm oil shortening, when the food product is cooked in 150 grams of palm olein at 180 degrees Celsius as measured during the first 30 seconds of cooking.

11. A method to reduce the formation of frost in frozen pre-fried food products, comprising:
pre-frying a food product in a oil compound; and
freezing the food product,
wherein the oil compound comprises:
between 90% and 99.99% by weight a mixture of vegetable oils, based on a total weight of the oil compound;
between 0.15% and 0.45% by weight emulsifier, based on a total weight of the oil compound; s and
between 0.01% and 0.02% antioxidants, based on a total weight of the oil compound.

12. The method of claim 9, wherein the food product is potato French fries.

13. The method of claim 10, wherein, when the food product is pre-fried with the oil compound for 60 seconds, an amount of frost formed in the frozen pre-fried food product is less than an amount of frost formed in a same frozen pre-fried food product prepared by pre-frying the food product for 60 seconds in palm oil shortening, when subjected to a 1 hour period of room temperature storage between periods of storage at a below freezing temperature.

14. The method of claim 12, wherein, an amount of spattering produced when the frozen pre-fried food product pre-fried with the oil compound is cooked in 150 grams of palm olein at 180 degrees Celsius as measured during the first 30 seconds of cooking is between 20% and 69% of the spattering produced by the pre-fried food product pre-fried with the palm oil shortening, when the food product is cooked in 150 grams of palm olein at 180 degrees Celsius as measured during the first 30 seconds of cooking.
